(19) United States
(12) Patent Application Publication
(10) Pub. No.: US 2006/0110048 A1
(43) Pub. Date: May 25, 2006

(54) System and method for characterizing 2-dimensional shapes by compactness measurements

(76) Inventors: Laurent Charlin, Montreal (CA); Li Zhang, Skillman, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/252,034

(22) Filed: Oct. 17, 2005

Related U.S. Application Data
(60) Provisional application No. 60/619,797, filed on Oct. 18, 2004.

(51) Int. Cl. G06K 9/62

(52) U.S. Cl. 382/224

(57) ABSTRACT

A method of classifying a shape in a digitized image includes determining a normalized compactness C_{DN} for an object in said image from the formula

$${C}_{DN} = \frac{Tn - P}{Tn - 4 \sqrt{n}} ,$$

wherein T is the connectivity of the object, n is the number of pixels in the object, and P is the length of the perimeter of the object, and classifying said object based on its normalized compactness value.

### CROSS REFERENCE TO RELATED UNITED STATES APPLICATIONS

This application claims priority from “Compactness Measurements for 2D shapes”, U.S. Provisional Application No. 60/619,797 of Charlin, et al., filed Oct. 18, 2004, the contents of which are incorporated herein by reference.

### TECHNICAL FIELD

This invention is directed to the characterization of irregularities in digitized medical images.

### DISCUSSION OF THE RELATED ART

The study of shapes is an important topic in computer vision. The basic descriptive properties of 2-dimensional shapes are area and perimeter. A measure of compactness for shapes relates the enclosing perimeter to the enclosed area, and has role in shape classification and analysis. In the analysis of digitized images, in particular medical images, it is of interest to find a method, invariant under geometric transformations, to calculate compactness. The term compactness does not refer in this context to point-set topology, but rather to the intrinsic property of a structure in an image. Thus, compactness is invariant under translation, rotation, and scaling. Compactness can be measured using the formula (P²/A), where P is an outer boundary of a shape and A is a surface area of the shape. This measure is dimensionless, and is minimized by a circle. Knowledge of a compactness measurement can be used by a segmentation algorithm to separate a target structure from other structures in the surrounding image, and to help identify the corresponding nodules, which could change size and have undergone small deformations in follow up imaging scans.

In the digital domain, many shapes do not have well defined contours, due to noise of the input devices used, and to digital quantization. The result are noisy contours and larger perimeters, which affect the measure of compactness. FIG. 1 illustrates the results of determining the compactness of shapes in the digital domain using the above definition. FIG. 1(a) depicts a circle having a well-defined contour, with a compact measure of 12.56 (=4π), while FIG. 1(b) depicts the same circle with a noisy contour, and where the compactness has been measured to be 29.67. This compactness measure is the same as the shape depicted in FIG. 1(c). FIG. 1(d) depicts another pathological case, the snowflake curve, a fractal curve which produces an aberrant compactness measure because its area remains constant as its perimeter grows in magnitude.

Thus, the current approach of measuring compactness using the formula (P²/A) has a drawback in that experiments have shown that even if it is immune to perfect scaling, it tends to perform poorly with noisy surfaces. That is to say, similar shapes might have a different compactness value, or a shape could significantly change its compactness value as it grows. The current approach therefore tends to be more of a method to compare different looking shapes and not necessarily to establish the correspondence of shapes. In addition, in the case of medical images, shapes, while retaining essentially the same form, can undergo small deformations due to changing resolution.

### SUMMARY OF THE INVENTION

Exemplary embodiments of the invention as described herein generally include methods and systems for calculating a compactness measure that can establish a correspondence between the same shape at different resolutions or at differing stages of growth.

According to an aspect of the invention, there is provided a method for classifying a shape in a digitized image comprising the steps of providing a digitized image comprising a plurality of intensities defined for a set of points on a 2-dimensional lattice, selecting an object from said image, defining a discrete compactness C_{D} for said object, defining a maximal compactness C_{D max} for said object, determining a normalized compactness C_{DN} for said object from said discrete compactness and said maximal compactness, and classifying said object based on its normalized compactness value.

According to a further aspect of the invention, the normalized compactness is defined by

$${C}_{DN} = \frac{{C}_{D}}{{C}_{D max}} .$$

According to a further aspect of the invention, the discrete compactness is defined by

$${C}_{D} = \frac{1}{2} ( Tn - P ) ,$$

wherein T is the connectivity of the lattice, n is the number of pixels in the object, and P is the length of the perimeter of the object.

According to a further aspect of the invention, the maximal compactness is defined by

$${C}_{D max} = \frac{1}{2} ( Tn - 4 \sqrt{n} ) .$$

According to a further aspect of the invention, the normalized compactness is defined by

$${C}_{DN} = \frac{Tn - P}{Tn - 4 \sqrt{n}} .$$

According to a further aspect of the invention, the lattice is a 4-connected grid.

According to a further aspect of the invention, the discrete compactness is defined by

$${C}_{D} = 2 n - \frac{1}{2} P ,$$

wherein n is the number of pixels in the object, and P is the length of the perimeter of the object.

According to a further aspect of the invention, the maximal compactness is defined by
C_{D max}=2(n−\sqrt{n}).

According to a further aspect of the invention, the normalized compactness is defined by

$${C}_{DN} = \frac{n - \frac{1}{4} p}{n - \sqrt{n}} .$$

According to another aspect of the invention, there is provided a program storage device readable by a computer, tangibly embodying a program of instructions executable by the computer to perform the method steps for classifying a shape in a digitized image.

### BRIEF DESCRIPTION OF THE DRAWINGS

FIGS. 1(a)-(d) illustrate the results of determining the compactness of shapes in the digital domain.

FIG. 2 is a table of comparisons of compactness measurements for circular shapes on a rectangular grid with different resolutions, according to an embodiment of the invention.

FIG. 3 is a graph of the results of the first 2 columns of FIG. 2, according to an embodiment of the invention.

FIG. 4 is a table of comparisons of normalized compactness for rectangular shapes whose area is a perfect square, according to an embodiment of the invention.

FIG. 5 is a graph of the compactness values of FIG. 4, according to an embodiment of the invention.

FIG. 6 is a table of compactness measurements of the right triangle illustrated in FIG. 10(e), according to an embodiment of the invention.

FIG. 7 is a table of compactness measurements of the shape depicted in FIG. 8, according to an embodiment of the invention.

FIG. 8 depicts a shape with an irregularly shaped hole, according to an embodiment of the invention.

FIG. 9 is a table of normalized compactness measurements for shapes depicted in FIGS. 10(a)-(i), according to an embodiment of the invention.

FIG. 10(a)-(i) depicts a variety of shapes, along with their classical compactness, according to an embodiment of the invention.

FIG. 11 is a block diagram of an exemplary computer system for implementing a compactness measurement scheme according to an embodiment of the invention.

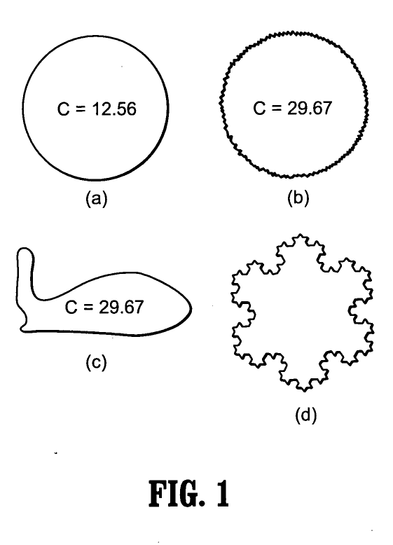

### DETAILED DESCRIPTION OF THE PREFERRED EMBODIMENTS

Exemplary embodiments of the invention as described herein generally include systems and methods for calculating a compactness measure of an object in a digitized medical image. Although exemplary embodiment of the invention herein disclosed are presented in terms of 2D images, it will be apparent to one skilled in the art that other embodiments of the invention can be extended to 3D images.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

An exemplary current method of measuring compactness (P²/A) of a simple shape uses the outer perimeter P of the shape to be measured. The perimeter of a shape composed of pixels corresponds to the sum of the lengths of the sides of the closed shape. This definition corresponds to the traditional notion of perimeter, and is referred to herein below as the shape perimeter. A complex shape on an image grid can also be described in terms of a contact perimeter P_{c}, which is the sum of the lengths of segments which are common to two cells in a shape. This can be understood as a number describing the degree to which the shape is touching itself.

The relationship between the shape perimeter and the contact perimeter, for any shape composed of n pixels, is given by the following:
2P_{c}+P=Tn,
where P is the shape perimeter, T is the number of sides of a cell, and n is the area or number of pixels of the shape. From this formula, the contact perimeter can be given by
P_{c}=½(Tn−P).
Note that this formula is not limited to pixels defined on a rectangular grid, but holds true for any cell pattern that can tessellate a plane, such as triangular cells and hexagonal cells. The number of cell sides would be 4 for an image with pixels on a lattice grid, where each 2D pixel borders 4 other pixels, a property referred to as four-connectivity. Thus, Tn represents the total number of sides of all the pixels in the shape, P represents the outside border, and P_{c} represents those segments common to two cells, which are counted only once, thus the multiplication factor of 2.

In the digital domain, a measure of discrete compactness C_{D} for a shape composed of n cells is defined to correspond to the contact perimeter: C_{D}=P_{c}. The discrete compactness is maximized by a shape in the form of the basic cell being used. For example, if a shape is composed of rectangular (or square) pixels, C_{D} is maximized by a square shape.

One difference between a calculating compactness of a shape with a smooth perimeter, and the calculating compactness of a digitized shape with a noisy perimeter is the shape which will be maximized by each. In the smooth case a circle (or a sphere in the 3D domain) is the most compact surface, as it is the shape with the smallest compactness value. In the digital domain, however, a square is now the most compact shape.

Although this compactness measure, C_{D}, is invariant under translation and rotation, it does not account for scaling, namely that a larger shape will have a larger compactness value than a smaller shape. One technique for accounting for scaling uses the normalized discrete compactness, C_{DN}, defined as a measure of the actual shape compared to the maximum value a shape of this size could have. It is helpful to define the maximum and minimum compactness of a given n-(pixel) area shape:

$${C}_{D min} = n - 1 , \\ {C}_{D max} = \frac{Tn - 4 \sqrt{n}}{2} .$$

With these definitions, C_{DN} would be

$${C}_{DN} = \frac{{C}_{D} - {C}_{D min}}{{C}_{D max} - {C}_{D min}} = \frac{( \frac{T}{2} - 1 ) n - \frac{P}{2} + 1}{( \frac{T}{2} - 1 ) n - 2 \sqrt{n} + 1} . \qquad ( 1 )$$

Equation (1) yields a number in the range of 0.0 to 1.0, with 1.0 being the most compact. The most compact form will have the shape of the primitive cell shape of the lattice. For example, if the lattice is comprised of hexagonal pixels, a hexagon would be the most compact shape. In a 4-connected lattice grid, where T=4, these definitions take the form:

$${C}_{D} = 2 n - \frac{1}{2} P ;$$

$${C}_{Dmax} = 2 ( n - \sqrt{n} ) ;$$

$${C}_{DN} = \frac{n - \frac{1}{2} P + 1}{n - 2 \sqrt{n} + 1} .$$

Note that in this case, the most compact shape will always be a square, for which C_{D max}=C_{D}.

One concern regarding the above definitions is the use of a square root in the equation for C_{D max}. This will affect every shape that is not a perfect square, with smaller shapes being more affected than larger shapes.

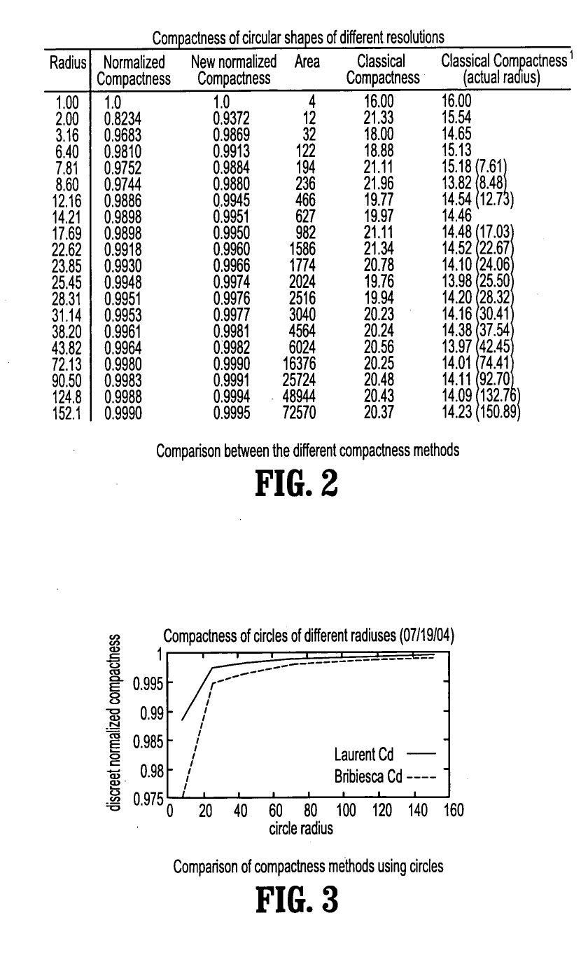

A comparison of compactness measurements for circular shapes on a rectangular grid with different resolutions is provided in the table depicted in FIG. 2. The left column of the table lists the radii of the shapes, the 1^{st} column to right of the radii lists the normalized discrete compactness measure, the 3^{rd} column to right of the radii lists the area in number of pixels, and the 4^{th} column lists the classical compactness, which assumes a smooth, non-noisy perimeter. The 2^{nd} column to right of the radii will be discussed below. The rightmost column presents the compactness measurement given when using an estimate of real perimeter of the shapes, where instead of counting 1 for every face of a pixels on the outer boundary of the shape, the \sqrt{2} was added for pixels adjacent in diagonals, and 1 was added for the other pixels. The numbers in parentheses to the right of the compactness measure is the equivalent radius of the shape when using this diagonalized perimeter. The results of the first 2 columns to the right of the radii are plotted in the graph of FIG. 3, which will be discussed below.

The classical compactness method should provide a reliable and consistent measure, but it assumes no noise in the figures. Note that it increases 30% when the radius increases from 1 to 2, and then fluctuates as much as 14% for larger radii, although the fluctuations decrease for increasing radius. By comparison, the classical compactness for the diagonalized perimeter is better behaved, although it decreases by about 12%. On the other hand, the normalized discrete compactness is relatively constant for increasing radii, although it exhibits an almost 20% decrease as the radius increases from 1 to 2.

As shown by these results, the normalized discrete compactness measure is insufficiently invariant when comparing shapes with a large magnitude difference. Intuitively, it would appear that the normalization insufficient to compensate for larger differences between C_{D} and C_{D min}. According to an embodiment of the invention, a technique of measuring compactness is defined by:

$${C}_{DN} = \frac{{C}_{D} / {C}_{D min}}{{C}_{D max} / {C}_{D min}} = \frac{{C}_{D}}{{C}_{D max}} = \frac{Tn - P}{Tn - 4 \sqrt{n}} . \qquad ( 2 )$$

This new compactness measure according to an embodiment of the invention replaces the minus sign for a divide sign, to compensate for the difference in the square root of the shape area (n). In a 4-connected lattice grid, this definition takes the form:

$${C}_{DN} = \frac{n - \frac{1}{4} P}{n - \sqrt{n}} .$$

Referring back to the table of FIG. 2, the 2^{nd} column to the right of the radii, labeled as “New normalized compactness”, lists compactness measures calculated according to equation (2). Note that these results exhibit smaller fluctuations than the prior art normalized compactness for increasing radii, and is much better behaved for smaller radii.

This improvement is apparent from the graph of FIG. 3, where a normalized compactness calculated for a circular shape on a square lattice according to an embodiment of the invention is indicated by the solid curve, and a prior art calculation of normalized compactness is indicated by the dotted curve. The compactness measures according to an embodiment of the invention are noticeable closer to the ideal normalized compactness value of 1.0 for these shapes.

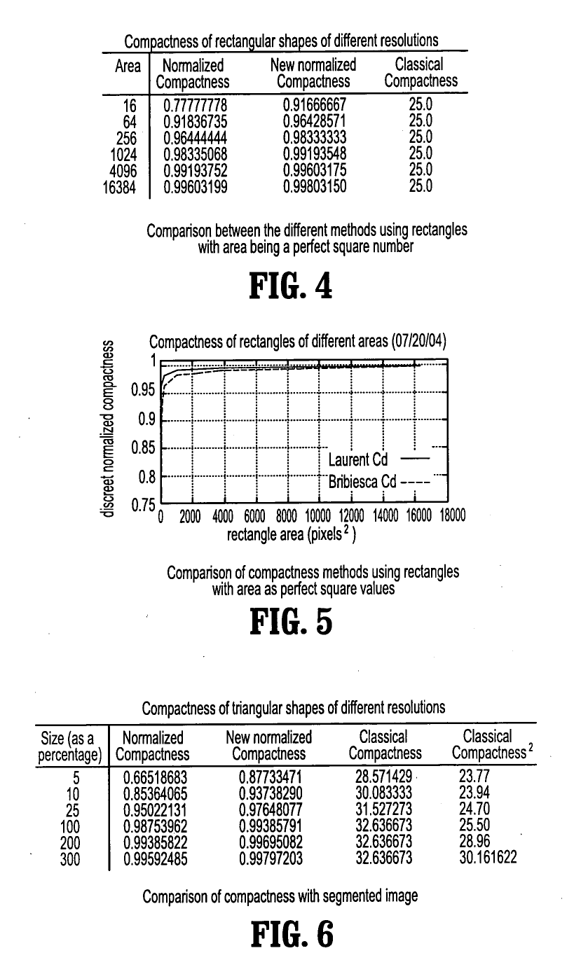

Comparisons of a normalized compactness measure according to an embodiment of the invention and a prior art normalized compactness measure are depicted in FIGS. 4 and 5, for rectangular shapes whose area (number of pixels) is a perfect square. Referring now to FIG. 4, the leftmost columns lists the area of the shapes, the 1^{st} column to the right lists the normalized compactness according to the prior art, the second column to the right lists the normalized compactness according to an embodiment of the invention, and the rightmost column lists the classical compactness for a smooth shape with the give area. The compactness values of FIG. 4 are plotted in the graph of FIG. 5, where the solid line represents values according to an embodiment of the invention, and the dotted lines represents values according to the prior art. As indicated by the figure, normalized compactness values according to an embodiment of the invention exhibit improved behavior over the domain of areas. In particular, for a shape with area=16, a normalized compactness according to an embodiment of the invention is within 9% of the ideal value, whereas the prior art normalized compactness is over 22% smaller than the ideal.

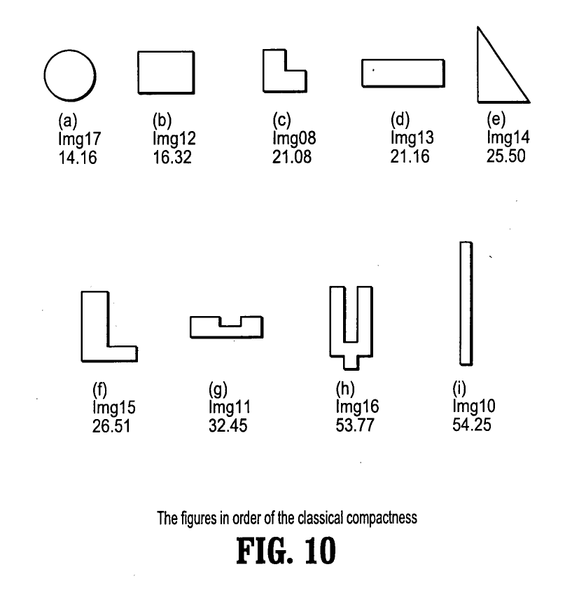

Another set of measurements, depicted in the table of FIG. 6, concerns the right triangle illustrated in FIG. 10(e). Referring now to FIG. 6, the leftmost columns lists the area of the triangle, the 1^{st} column to right of the radii lists the prior art normalized discrete compactness measure, the 2^{nd} column to right of the radii lists a normalized compactness according to an embodiment of the invention, the 3^{rd} column lists the classical compactness, which assumes a smooth, non-noisy perimeter, and the rightmost column presents the compactness measurement given when using the diagonalized perimeter as described above. A normalized compactness according to an embodiment of the invention performs better than the prior art measure for all sizes. In particular, for the smallest size, a normalized compactness according to an embodiment of the invention is within 13% of the ideal value, while the prior art value is almost 34% lower than the ideal value.

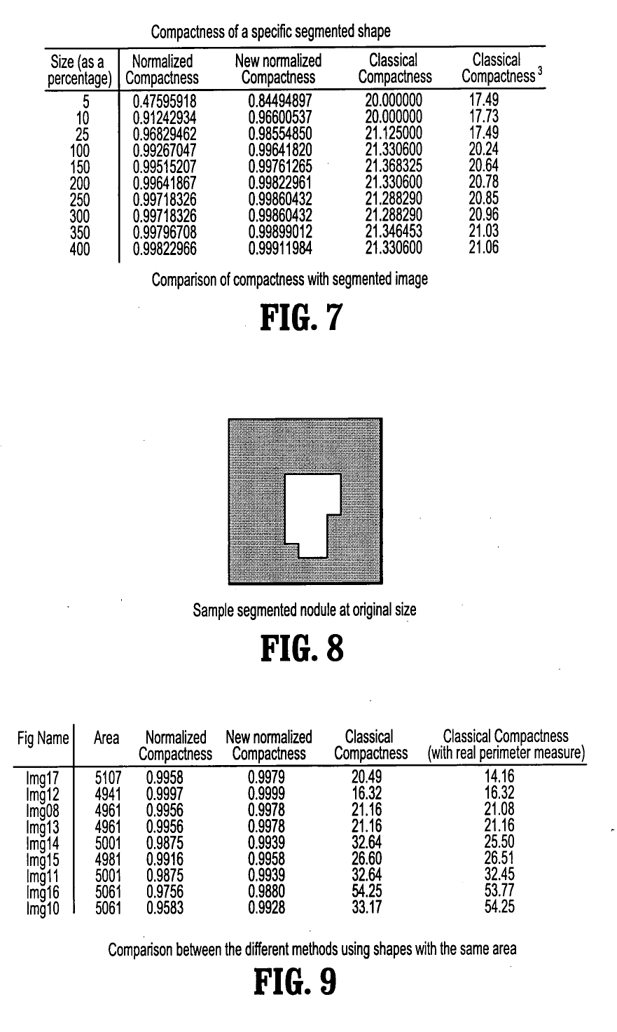

Another series of comparisons concerns compactness measurements for a shape with an irregularly shaped hole, depicted in FIG. 8. FIG. 7 is a table of compactness measurements of this shape at different resolutions, as compared with the size of the original shape in FIG. 8. The columns in this table correspond to the columns of the table in FIG. 6. Note again that a normalized compactness measure according to an embodiment of the invention has improved behavior with respect to then ideal compactness value as opposed to the prior art values, with the improvement being most pronounced at low resolution, where the prior art compactness value is over 50% smaller, versus about 15% for a compactness according to an embodiment of the invention.

Further comparisons of normalized compactness measurements for other differing shapes are displayed in the table of FIG. 9. The figure names in the left column refer to one of the shapes depicted in FIGS. 10(a)-(i). These shapes include a circle, a square, two rectangles, a triangle, and several complex polygonal shapes formed from composites of rectangles. These shapes are depicted in FIGS. 10(a)-(i) in order of increasing classical compactness, which is indicated under the shape name. The columns in the table of FIG. 9 are, starting from the first column to the right of the figure names, are the figure area (in pixels), a prior art normalized compactness, a normalized compactness according to an embodiment of the invention, a classical compactness (assuming a smooth perimeter), and classical compactness for a diagonalized perimeter. Note again that a normalized compactness according to an embodiment of the invention show less variation (1% or less) over the various shapes than does the prior art normalized compactness, where the variation is up to 4%. However, in the case that it is desired to distinguish these shapes, other compactness measures can be used.

Although the classical measure of compactness is invariant to scaling, it assumes a smooth, continuous perimeter, a condition that is not satisfied by many digitized images. A compactness measurement according to an embodiment of the invention provides a measure that is robust with respect to noise and is essentially invariant to scaling and changes in resolution. This measure is useful as an initial step in shape detection, wherein two shapes with a large difference in their discrete compactness measure need not be compared.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

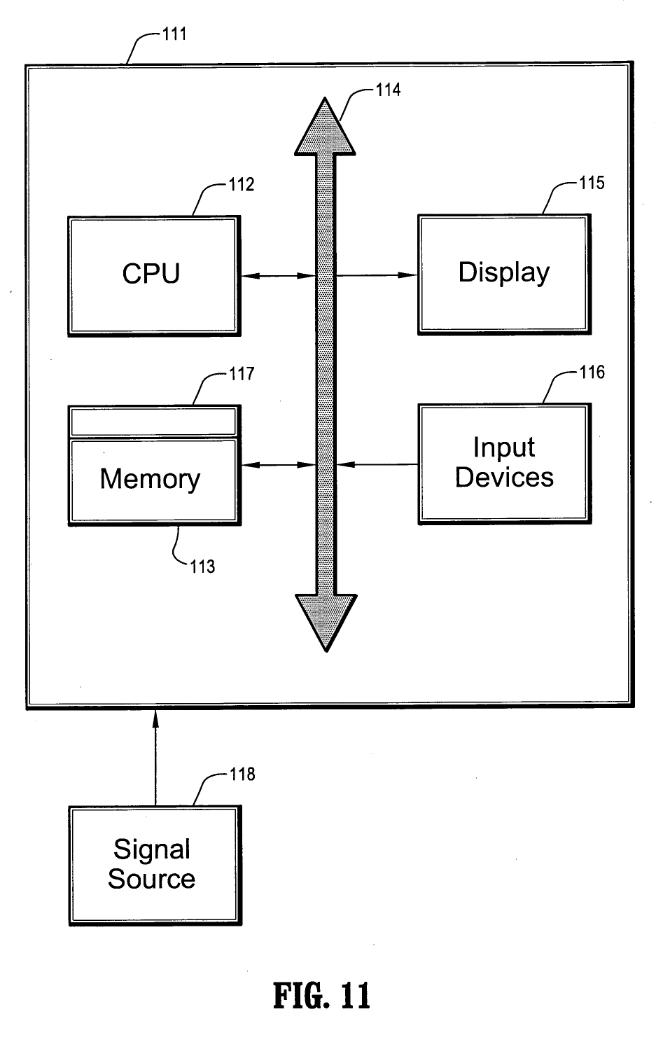

FIG. 11 is a block diagram of an exemplary computer system for implementing a compactness measurement scheme according to an embodiment of the invention. Referring now to FIG. 11, a computer system 111 for implementing the present invention can comprise, inter alia, a central processing unit (CPU) 112, a memory 113 and an input/output (I/O) interface 114. The computer system 111 is generally coupled through the I/O interface 114 to a display 115 and various input devices 116 such as a mouse and a keyboard. The support circuits can include circuits such as cache, power supplies, clock circuits, and a communication bus. The memory 113 can include random access memory (RAM), read only memory (ROM), disk drive, tape drive, etc., or a combinations thereof. The present invention can be implemented as a routine 117 that is stored in memory 113 and executed by the CPU 112 to process the signal from the signal source 118. As such, the computer system 111 is a general purpose computer system that becomes a specific purpose computer system when executing the routine 117 of the present invention.

The computer system 111 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method of classifying a shape in a digitized image comprising the steps of:
providing a digitized image comprising a plurality of intensities defined for a set of points on a 2-dimensional lattice;
selecting an object from said image;
defining a discrete compactness C_{D} for said object;
defining a maximal compactness C_{D max} for said object;
determining a normalized compactness C_{DN} for said object from said discrete compactness and said maximal compactness; and
classifying said object based on its normalized compactness value.

2. The method of claim 1, wherein said normalized compactness is defined by
$${C}_{DN} = \frac{{C}_{D}}{{C}_{D max}} .$$

3. The method of claim 1, wherein said discrete compactness is defined by
$${C}_{D} = \frac{1}{2} ( Tn - P ) ,$$
wherein T is the connectivity of the lattice, n is the number of pixels in the object, and P is the length of the perimeter of the object.

4. The method of claim 3, wherein said maximal compactness is defined by
$${C}_{D max} = \frac{1}{2} ( Tn - 4 \sqrt{n} ) .$$

5. The method of claim 4, wherein said normalized compactness is defined by
$${C}_{DN} = \frac{Tn - P}{Tn - 4 \sqrt{n}} .$$

6. The method of claim 1, wherein said lattice is a 4-connected grid.

7. The method of claim 6, wherein said discrete compactness is defined by
$${C}_{D} = 2 n - \frac{1}{2} P ,$$
wherein n is the number of pixels in the object, and P is the length of the perimeter of the object.

8. The method of claim 7, wherein said maximal compactness is defined by
C_{D max}=2(n−\sqrt{n}).

9. The method of claim 8, wherein said normalized compactness is defined by
$${C}_{DN} = \frac{n - \frac{1}{4} p}{n - \sqrt{n}} .$$

10. A method of classifying a shape in a digitized image comprising the steps of:
determining a normalized compactness C_{DN} for an object in said image from the formula
$${C}_{DN} = \frac{Tn - P}{Tn - 4 \sqrt{n}} ,$$
wherein T is the connectivity of the object, n is the number of pixels in the object, and P is the length of the perimeter of the object; and
classifying said object based on its normalized compactness value.

11. The method of claim 10, wherein said object is selected from a digitized image comprising a plurality of intensities defined for a set of pixels in a 2-dimensional lattice.

12. The method of claim 11, wherein the lattice is a rectangular lattice, wherein the connectivity T=4.

13. The method of claim 11, wherein the lattice is a triangular lattice, wherein the connectivity T=3.

14. The method of claim 11, wherein the lattice is a hexagonal lattice, wherein the connectivity T=6.

15. A program storage device readable by a computer, tangibly embodying a program of instructions executable by the computer to perform the method steps for classifying a shape in a digitized image, said method comprising the steps of:
providing a digitized image comprising a plurality of intensities defined for a set of points on a 2-dimensional lattice;
selecting an object from said image;
defining a discrete compactness C_{D} for said object;
defining a maximal compactness C_{D max} for said object;
determining a normalized compactness C_{DN} for said object from said discrete compactness and said maximal compactness; and
classifying said object based on its normalized compactness value.

16. The computer readable program storage device of claim 15, wherein said normalized compactness is defined by
$${C}_{DN} = \frac{{C}_{D}}{{C}_{D max}} .$$

17. The computer readable program storage device of claim 15, wherein said discrete compactness is defined by
$${C}_{D} = \frac{1}{2} ( Tn - P ) ,$$
wherein T is the connectivity of the lattice, n is the number of pixels in the object, and P is the length of the perimeter of the object.

18. The computer readable program storage device of claim 17, wherein said maximal compactness is defined by
$${C}_{D max} = \frac{1}{2} ( Tn - 4 \sqrt{n} ) .$$

19. The computer readable program storage device of claim 18, wherein said normalized compactness is defined by
$${C}_{DN} = \frac{Tn - P}{Tn - 4 \sqrt{n}} .$$

20. The computer readable program storage device of claim 15, wherein said lattice is a 4-connected grid.

21. The computer readable program storage device of claim 20, wherein said discrete compactness is defined by
$${C}_{D} = 2 n - \frac{1}{2} P ,$$
wherein n is the number of pixels in the object, and P is the length of the perimeter of the object.

22. The computer readable program storage device of claim 21, wherein said maximal compactness is defined by
C_{D max}=2(n−\sqrt{n}).

23. The computer readable program storage device of claim 22, wherein said normalized compactness is defined by
$${C}_{DN} = \frac{n - \frac{1}{4} p}{n - \sqrt{n}} .$$
